(19) United States
(12) Patent Application Publication
(10) Pub. No.: US 2006/0073327 A1
(43) Pub. Date: Apr. 6, 2006

(54) Opaque decorative film and construction laminates employing same

(76) Inventors: Benjamin Tuttle, Schwenksville, PA (US); Ronald Rodeck, Hockessin, DE (US)

Correspondence Address: CAESAR, RIVISE, BERNSTEIN,;COHEN & POKOTILOW, LTD., 11TH FLOOR, SEVEN PENN CENTER, 1635 MARKET STREET, PHILADELPHIA, PA, 19103-2212, US

(21) Appl. No.: 10/959,525

(22) Filed: Oct. 6, 2004

(51) Int. Cl. B32B 7/12; B32B 29/00; B32B 27/32; B32B 13/00

(52) U.S. Cl. 428/343; 428/523; 428/703; 428/532

(57) ABSTRACT

A monolayer or multilayer film having a desired decorative appearance for use as an overlay to cover substrates employed in the construction field to provide construction laminates having a desired decorative appearance. The film overlays include, on one surface thereof, a functional adhesive primer for receiving an aqueous adhesive thereon for bonding the film to the substrates. The film includes an opposed surface having a desired decorative appearance. In one preferred embodiment the monolayer film or core layer of the multilayer film includes a polyolefin blended with approximately 15%-20% by weight thereof of a whitening agent such as titanium dioxide; without the use of a void-creating additive. In certain multilayer film embodiments the core layer can include a void creating additive, either without a whitening agent or preferably with less than 5% by weight of a whitening agent. Laminates including the film overlays of this invention bonded to substrates to form construction panels also form a part of the invention.

### BACKGROUND OF THE INVENTION

The prior art literature discloses the use of opaque polypropylene films including organophilic Kaolin in it, for use in laminating to paper and paperboard substrates of lower brightness than the film, for the purpose of providing a decorative coating. The disclosed polypropylene films are biaxially oriented and include 20%, by weight, of the organophilic Kaolin.

The literature further discloses the coating of the Kaolin-filled, polypropylene films with a clay-starch coating that is strong enough to enable the use of heat-set letterpress inks in printing. The literature also states that the coating of the plastic film improved the sheet stiffness and “rattle” and appears to offer an approach for producing plastic films with paper-like properties.

Although the prior art literature discloses polyolefin films with Kaolin for use as a decorative covering for paper and paperboard substrate (e.g., packaging or wrapping materials), a need exists to provide such a decorative film laminates employed in the construction field, such as decorative laminates employed in the fabrication of ceilings and walls and in the construction of furniture, e.g., cabinets, shelving, desks, etc. Such decorative films need to have the desired adhesive characteristics to firmly retain the film on a desired, substantially rigid substrate with conventional water-based adhesives; with the failure mode, upon peeling of the film from the substrate, being at the adhesive, substrate interface. Moreover, for furniture and similar products the decorative films of the laminates need to be sufficiently durable to withstand the mechanical abuse, or wear, to which such products are commonly exposed. For other applications, such as in wall and ceiling panel laminates, the degree of durability of the decorative film need not be as great as for furniture and related applications. It is to decorative films of variable durability and construction laminates employing such films as overlays that the present invention relates.

### SUMMARY OF THE INVENTION

A monolayer or multilayer polyolefin film includes opposed surfaces. One of said surfaces receives a water-based adhesive thereon for securing the film to a desired construction substrate, as an overlay. The opposed surface is visually exposed to provides the desired, decorative surface appearance to the laminate.

Unless specified otherwise, reference throughout this application to a surface of the film or laminate providing a desired “decorative surface appearance,” “a decorative appearance,” or descriptions of similar import, includes both surfaces that are not printed with a separate decorative pattern (i.e., the decorative appearance is provided by the as formed shade or color of the exposed surface of the film or laminate), and surfaces that are printed to provide a separate decorative pattern on the visually exposed surface of the film or laminate.

In accordance with an important aspect of this invention, the surface for receiving the water-based adhesive is first provided with a coating of a functional adhesive primer, preferably a polar adhesive primer that effectively adheres to the polyolefin film surface and provides a primer coating to tenaciously receive a conventional water-based adhesive thereon.

The monolayer film or the core layer of a multilayer film in accordance with one form of this invention is a highly durable film that includes 15-20% by weight of a whitening agent, such as titanium dioxide, and is free of any void creating additives, such as calcium carbonate.

In accordance with another aspect of this invention, when high durability to mechanical abuse or wear is not a significant issue, multilayer films of this invention can include a conventional voiding agent, e.g., calcium carbonate, in a core layer thereof, to provide a reduced density film that is less durable to mechanical abuse than a decorative film free of void creating additives. Such reduced density films can be desirably employed for a number of applications, such as in the fabrication of decorative wall and ceiling panels, where durability and physical abuse or wear of the surface is not a major problem. When a voiding agent is employed in the core layer the level of whitening agent desirably is substantially reduced, e.g., to less that 5% and more preferably to a range of about 1.5% to about 3%, since the primary objective of the whitening agent, as well as the voiding agent, is to provide opacity, with the color being less significant.

The films of this invention employing a voiding agent are multilayer films, with a voiding agent included in the core layer. Monolayer films including a voiding agent are not sufficiently durable or strong for use in the construction laminates of this invention.

Although when a voiding agent is employed in the core layer it also is believed to be important to include at least a small percentage of a whitening agent in the core layer to provide an acceptable surface appearance, it is within the broadest scope of this invention to eliminate the use of a whitening agent in a core layer that includes a voiding agent therein. However, it should be emphasized that in the applications contemplated in this invention, it is unlikely that a film including only a voiding agent in the core layer, without a whitening additive such as titanium dioxide, will provide the desired visual appearance to render a construction laminate employing the film acceptable for its intended use.

In a preferred embodiment, the functional adhesive primer is a water-based primer and most preferably is a polar, acrylic-based coating (e.g., Adcote 611JH64A manufactured by Rohm & Haas, which is located in Philadelphia, Pa., NeoCryl XK90 and NeoCryl 5045 manufactured by NeoResins, which has its World Headquarters in The Netherlands and its North American Headquarters in Wilmington, Mass.). However, within the broadest scope of the invention other water-based or solvent based materials can be employed as the functional adhesive primer, such as urethane-based coatings (e.g., NeoResins R600 manufactured by NeoResins), polyethylene Imines (PEI) (e.g., Mica A-131-X, produced by MICA Corporation of Shelton, Conn.), ethylene vinyl acetates (e.g., Adcote 37P295 and Adcote 37T77 manufactured by Rohm & Hass), polyesters (e.g., Eastek 1200 and 1300 manufactured by Lawter, a division of Eastman Chemical Company located in Pleasant Prairie, Wis.), polyamides (e.g., Versamid 973 manufactured by Cognis Corporation in Ambler, Pa.), etc. The above-identified functional adhesive primers are exemplary only. A person skilled in the art and understanding the required attributes of the primer can easily determine acceptable adhesive primers for use within the broadest scope of this invention.

As noted, above, in the most preferred embodiments of this invention the functional adhesive primer is water-based. However, it should be noted that Versamid 973 (a polyamide) is not water based, but rather is a solid composition of acetate and toluene. This latter solvent is not well suited for in-line application, e.g., application between the machine direction and cross-machine direction orientation step in a conventional film forming line, in part because of the cost of equipment that would be required to be included in the line to effectively and properly handle such solvent based materials (e.g., oxidative systems for use in disposing of the evaporated solvent). In addition, PEI also is not well suited for in-line application because it has inadequate stretch properties for such use. Thus, for in-line application, which is the preferred method of forming the decorative films of this invention, the primer must have sufficient stretch properties to be able to withstand the transverse stretching operation after application to the film.

Thus, in the most preferred embodiments of this invention the functional adhesive primers are water-based coatings that are applied in-line to the polyolefin film by a conventional gravure printing operation after the film has been oriented in the machine direction, but prior to orientation of the film in the cross-machine direction. Although the preferred film is formed in-line in a conventional tenter machine with the coating applied between the machine direction and cross-machine direction orientation steps, it is within the broadest scope of this invention to apply the adhesive primer to the film in a separate, off-line operation. In an off-line system capable of handling solvent-based systems a solvent based primer may be usable.

One of the significant benefits of this invention is that conventional, well-known, water-based adhesives can effectively be utilized to adhere the film to a desired substrate of the type employed in the construction field. Representative water-based adhesives usable in this invention are synthetic polymer adhesives (e.g., Bondmaster Vy-Lok 40-1105 and BondMaster 40-0844 manufactured by National Adhesives, a division of National Starch located in Salisbury NC., and #60 manufactured by Sun Adhesives Corporation in Decatur, Ala.) and ethylene vinyl acetate adhesive emulsions (e.g., #7200 manufactured by Sun Adhesives), although people skilled in the art clearly can select other water-based adhesives that would be usable in this invention.

Although the functional water-based adhesive primer and water-based adhesive can be applied to a monolayer polyolefin film, such as a monolayer film including one or more polyolefins, in the most preferred embodiment of this invention the film for receiving the functional water-based coating and water-based adhesive is a multilayer structure including a central core and opposed outer skin layers.

### DESCRIPTION OF PREFERRED EMBODIMENTS

As noted earlier, this invention relates broadly to both monolayer and multilayer polyolefin films and to laminates employed in the construction field and including those films as overlays. In the most preferred embodiments the film is a multilayer film including a central core and opposed outer skin layers. In fact, only multilayer films are usable when a voiding agent is employed to provide enhanced opacity to the film, as was described above.

The monolayer films of this invention and the internal core layer of the multilayer films of this invention are principally a polyolefin and most preferably a polypropylene.

“Polypropylene” as utilized in this application includes, for example, polypropylene homopolymers and propylene copolymers, including but not limited to block copolymers. The term “propylene copolymers” includes polymers of propylene with at least one other α-olefin, preferably C₂C₃ copolymers with less than 10% by weight C₂ or C₃C₄ copolymers with less than 30% C₄.

In one preferred embodiment, which is very durable to mechanical abuse, the monolayer film or the core layer in the multilayer film includes primarily homopolymer polypropylene, 15 to 20% of a whitening agent, such as titanium dioxide, a minor percentage of a UV stabilizer, and is free of a void-creating additive. It is within the scope of the invention to employ mini random C₂C₃ copolymers including less than 1% C₂ in place of, or in addition to the homopolymer polypropylene. Moreover, as will be discussed in greater detail hereinafter, in certain preferred embodiments, where durability to mechanical abuse is not a significant issue, a voiding agent can be included in the core layer of a multilayer film of the invention to provide a reduced density, lower cost structure (e.g., lower cost per unit area) with the desired opacity. In these latter embodiments, which only include multilayer films of the invention, the amount of whitening agent that is employed can be substantially reduced, e.g., to a level less than 5% and more preferably to a level of about 1.5% to about 3%. Although, in accordance with the broadest aspect of this invention it may be possible to eliminate the use of a whitening agent when a voiding agent is employed in the core layer, such a film most likely will not have the decorative appearance desired for most end-use applications.

In one preferred construction, the monolayer film of the invention and the core layer of the multilayer film of the invention includes 52% Fina 3371 (homopolymer polypropylene), 45% WP240 (40% titanium dioxide in a carrier of 60% Sunoco XJ-015, a mini random ethylene/propylene random copolymer including approximately 0.6% ethylene manufactured by the Polymer Division of Sunoco, Inc., located in Pittsburgh, Pa.) and 3% Ampacet 402705 (15% Tinuvin 783 (UV stabilizer) and 5% Armostat 300 (antistat) in a carrier of 85% homopolymer polypropylene).

Fina 3371 is manufactured by ATOFina Petrochemicals, Inc. located in Houston, Tex. WP 240 is manufactured by Washington Penn Plastics Co., Inc. in Washington, Pa., and Ampacet 400943 is manufactured by Ampacet Corporation in Tarrytown, N.Y.

In a preferred structure, the skin layer for receiving a functional, water-based adhesive primer thereon is a polypropylene, and more preferably is 97.4% Sunoco XJ-015 mini random copolymer of ethylene and propylene manufactured by Sunoco, Inc., located in Pittsburgh, Pa. and 2.6% Ampacet 402705 (15% by weight Tinuvin 783 (UV stabilizer) and 5% Armostat 300 (antistat) in 85% by weight homopolymer polypropylene). The main function ofthe skin layer is to present a smooth surface to the gravure printing roll employed to dispense or meter a coating of the functional, water-based adhesive primer onto the outer exposed surface thereof in the most preferred, in-line forming operation. If this skin layer were not employed, the gravure printing roll would directly contact the more abrasive outer surface of the core layer, and would tend to experience undesired wear. It should be understood that the core layer is more abrasive as a result of the high concentration of titanium dioxide included in some embodiments of the invention and the inclusion of a high concentration of a void-creating additive in other embodiments of the invention.

The opposed skin layer is the visually exposed surface of the laminate required to provide the desired decorative appearance in the construction laminates of this invention, as will be described in greater detail hereinafter. In certain preferred embodiments this opposed skin layer is provided with a desired decorative appearance by the inclusion of a printed pattern thereon. However, in accordance with the broadest aspect of this invention, the films of this invention can be sold as-is, without a separate, decorative printed pattern an opposed skin layer thereof.

If desired, or required, the opposed skin layer (i.e., the skin layer opposed to the one that receives the primer and adhesive thereon) can be provided with a conventional protective coating to provide scuff and scratch resistance to the surface, and also, if desired, can be provided with a metallized surface; e.g., aluminum, as is well known in the art. It should be understood that the particular protective coating or metal coating or layer that is employed is not a limitation on the broadest aspects of this invention, since suitable protective coatings, as well as metals employed to form a very thin metallized layer are well known to those skilled in the art. This opposed skin surface is selected to provide the desired gloss in the completed decorative product, and for many applications the desired appearance requires a low gloss surface.

In a preferred embodiment of this invention, the skin layer providing the visually exposed surface of the film is a low gloss surface formed of polypropylene, and more preferably of a blend including over 50%, and more preferably 65%, of an ethylene/propylene copolymer including less than 10% ethylene in it. Most preferably the copolymer that is employed is sold by ATOFina under the designation Fina 8573; including approximately 4.5% ethylene in it. The ethylene propylene copolymer is blended with approximately 32% of a calcium carbonate concentrate sold by Ampacet Corporation located in Tarrytown, N.Y., under the designation Ampacet 411342, and 3% of a UV stabilizer concentrate sold under the designation Ampacet 402705.

The Ampacet 411342 concentrate employed in the decorative, or printable, layer is in the form of blended pellets including 62.5% by weight calcium carbonate (approx. 3 microns), 7.5% by weight titanium dioxide, and 29.37% by weight of Sunoco XJ-015 mini-random copolymer of ethylene and propylene and 0.63 by weight antioxidants. Thus, the actual percentage by weight of calcium carbonate in the decorative layer is 20% by weight (32%×62.5%) and the percentage of titanium dioxide in the printable layer is 2.4% by weight (32%×7.5%).

The Ampacet 402705 in the decorative layer also is in the form of blended pellets including 15% Tinuvin 783 (UV stabilizer) by weight in 85% by weight homopolymer polypropylene carrier.

The preferred formulation for the outer visually exposed skin layer, which can, if desired, be a printable layer, is selected to provide a desired low gloss surface, which is referred to as a satin appearance. It should be understood that the formulation of the skin layer can be modified depending on the desired gloss of the surface. The inclusion of a separate, outer skin layer on the surface of the core opposed to the adhesive receiving surface provides a basis for controlling the gloss of the visually perceptible surface in the completed, laminated constructions of this invention.

All references to percentages of the various components in the films of this invention are percentages by weight.

Preferably the core layer of the multilayer films of this invention is the thickest component, with the skin layers and water-based primer coating including only a small percentage of the thickness of the film. However, it is within the scope of this invention to vary the thickness of the various components and in some cases the core layer may not be the thickest component. In a representative, non-limiting embodiment of this invention wherein the core layer is not voided, the core layer is approximately 196 gauge (1.96 mil) thick, the printable, or otherwise viewable skin layer is approximately 12 gauge (0.12 mil) thick, the skin layer for receiving the water-based primer is approximately 10 gauge (0.1 mil) thick and the water-based coating on this latter skin layer is approximately 2 gauge (0.02 mil) thick. In embodiments employing a voided core the thickness of the core will be somewhat higher, e.g., on the order of 300 gauge (3 mil).

Most preferably the decorative skin layer, when intended to receive a printing ink thereon, is oxidatively treated; preferably corona treated, to enhance ink receptivity, as is well known in the art.

The polyolefin film, with the functional adhesive primer thereon can be employed as a decorative covering, or overlay, for a number of substrates employed in the construction field, and most desirably substrates employing a wood grain that is intended to be covered or masked by the overlay. For example, the decorative films of this invention can be bonded through conventional water-based adhesives to gypsum, lauan plywood, medium density fiberboard, hardboard, particle board and other similar, as well as dissimilar substrates employed in the construction field. It is very desirable in this invention to provide a functional adhesive primer that maintains a strong inter-surface bond to the outer layer of the polyolefin film on one side of said primer, and to the water-based adhesive layer on the opposed side of said primer. Specifically, the glue desirably should be tenaciously retained on the decorative film structure, or overlay, such that, upon peeling the decorative film overlay off of a substrate that is usable in the construction field, to which it is attached, the separation takes place at the glue-substrate interface, with fibers of the substrate (when the construction substrate includes wood fibers) actually being adhered to the adhesive layer at the surface of separation. In other words, the decorative film, upon being peeled from a wood or fibrous construction substrate to which it is laminated, in most instances will have fibers of the substrate retained therein.

As pointed out herein, the laminates of the present invention are construction laminates, as opposed to laminates in which the substrate is a more flexible paper or paperboard substrate of the type employed in product packaging applications. For example, preferred laminate constructions of this invention are employed as wall panels, ceiling panels, panels for cabinet liners, panels for other furniture and for moldings.

In some applications, the use of calcium carbonate or other void creating additives to form substantial voids in the monolayer structures of this invention or in the core layer of the multilayer structures of this invention is avoided to provide a structure that is more durable to mechanical abuse or wear than one including a voiding agent, and also to prevent an undesirable reduction in the Z direction strength of the film close to the bonded interface between the film and a construction substrate to which it is laminated. The creation of such an undesirable reduction in the Z direction strength might cause the film to tear through the core and/or skin layer on which the primer and adhesive is retained, upon separation of the film from the substrate to which it is attached. In addition, as noted above, for certain applications where stringent durability requirements exist, such as in furniture and shelving constructions, voided structures are generally avoided. The preferred standard in the industry is that upon peeling the decorative film overlay from a wood substrate, separation should take place at the bonded interface of the film to that substrate, and that the film should not experience a Z direction tearing through other components of the film, such as through the core layer and the skin layer including the primer and adhesive that are weakened by the inclusion of calcium carbonate or a similar void-creating additive.

However, in certain preferred embodiments of this invention wherein durability to mechanical abuse or wear are not issues of concern, lower density, multilayer films are desired; principally to reduce cost per unit weight. In these latter embodiments, void-creating additives, e.g., synthetic, natural or organic, can be employed in the core layer of the multilayer films. Desirably the void-creating additive should be present in amounts, by weight, between about 10 and 25%, and most preferably is calcium carbonate in the particle size range of 1-5 microns. The type of void-creating additives employed in this invention is not a limitation on the broadests aspects of this invention, and can include other additives, such as silicon dioxide, aluminum silicate, magnesium silicate, organic voiding agents and synthetic voiding agents, to name a few. When a void creating additive is employed, the amount of whitening agent, e.g., titanium dioxide, can be substantially reduced since the required opacity is provided in large part by the void creating additive. In a preferred embodiment the whitening agent can be reduced to below 5%, and more preferably in the range of about 1.5% to about 3% by weight, when a voiding agent is employed in the desired range. As noted earlier herein, monolayer films are not considered suitable for use as an overlay in a construction laminate when a voiding agent is intended to be included in the film forming the overlay. Also, although the level of whitening agent most preferably is reduced when a voiding agent is employed in the core layer of a multilayer film of this invention, it is possible to use the same high levels of whitening agent employed in films that do not include a voiding agent therein.

It should be understood that other conventional additives may be added to one or more of the layers in the films of this invention. Such conventional additives include, but are not limited to pigments, orientation stress modifiers, antiblocking agents and slip agents.

Another class of additives that may be included in the compositions of the invention is low molecular weight hydrocarbon resins (frequently referred to as “hard resins”). The term “low molecular weight hydrocarbon resins” refers to a group of hydrogenated or unhydrogenated resins derived from olefin monomers, such as the resins derived from terpene monomers, coal tar fractions and petroleum feedstock. Suitable such resins prepared from terpene monomers (e.g., limonene, alpha and beta pinene) are Piccolyte resins from Hercules Incorporated, Wilmington, Del., and Zonatac resins from Arizona Chemical Company, Panama City, Fla. Other low molecular weight hydrocarbon resins are prepared from hydrocarbon monomers, as C₅ monomers (e.g., piperylene, cyclopentene, cyclopentadiene and isoprene), and mixtures thereof. These are exemplified by the hydrogenated thermally oligomerized cyclopentadiene and di cyclopentadiene resins sold under the trade name Escorez (for example, Escorez 5300) sold by Exxon Chemical Co., of Baytown, Tex. Others are prepared from C₉ monomers, particularly the monomers derived from C₉ petroleum fractions which are mixtures of aromatics, including styrene, methyl styrene, a-methyl-styrene, vinyl naphthalene, the indenes and methyl indenes and additionally pure aromatic monomers, including styrene, a-methyl-styrene and vinyltoluene. Examples of these resins include hydrogenated a-methyl-styrene-vinyl toluene resins sold under the trade name Regalrez by Hercules of Wilmington, Del.

In general, the low molecular weight resins that can be included in the compositions of this invention that are characterized by a molecular weight less than about 5,000, a Tg of about 50-100° C. and a softening point less than about 140° C.

Without further elaboration, the foregoing will so fully illustrate my invention that others may, by applying current or future knowledge; readily adopt the same for use under various conditions of service.

What we claim as the invention is the following:

1. A decorative film for use as an overlay for a substrate employed in laminates utilized in the construction field, said decorative film being a monolayer film or a multilayer film including a core layer, said film including on one surface thereof, a functional adhesive primer intended to receive an aqueous adhesive thereon, said film including an opposed surface having a desired decorative appearance, said monolayer film or the core layer of said multilayer film including a polyolefin blended with approximately 15%-20% of a whitening agent, by weight, based upon the weight of the polyolefin in said monolayer film or of the polyolefin in the core layer of said multilayer film.

2. The decorative film of claim 1, wherein said polyolefin is polypropylene.

3. The decorative film of claim 1, being a multilayer structure having a core layer and opposed outer skin layers, said blend of polyolefin and whitening agent being in said core layer.

4. The decorative film of claim 1, wherein said whitening agent is titanium dioxide.

5. The decorative film of claim 4, wherein said titanium dioxide is present in an amount of approximately 18%.

6. The decorative film of claim 1, wherein said functional adhesive primer is selected from the group consisting of acrylic coatings, ethylene vinyl acetate coatings, polyethylene imine coatings, polyester coatings, polyamide coatings and urethane coatings.

7. The decorative film of claim 3, including a void-creating additive in the core layer.

8. The decorative film of claim 7, said void creating additive being present in an amount of about 10% to about 25%, by weight of said core layer.

9. The decorative film of claim 7, wherein said void creating additive is calcium carbonate.

10. The decorative film of claim 3, wherein said core layer is substantially free of a void-creating additive.

11. A decorative, laminate structure including the decorative film of claim 1 adhered as an overlay to a substrate employed in the construction field through a water-based adhesive disposed between the functional adhesive primer and the substrate to form a laminated construction panel.

12. The laminate structure of claim 11, wherein said substrate is selected from the group consisting of gypsum, lauan plywood, medium density fiberboard, hardboard and particle board, said decorative film being an overlay covering said substrate to form said laminated construction panel.

13. The laminate structure of claim 11, being in the group of construction laminates consisting of wall panels, ceiling panels, panels for cabinet liners, panels for other furniture and moldings.

14. The laminate structure of claim 12, being in the group of construction laminates consisting of wall panels, ceiling panels, panels for cabinet liners, panels for other furniture and moldings.

15. A film overlay for use in covering a substrate employed in laminates utilized in the construction field, said film overlay being a multilayer film including a core layer and opposed outer skin layers, said film overlay including on one surface thereof, a functional adhesive primer intended to receive an aqueous adhesive thereon, said film including an opposed surface providing a desired decorative appearance, said core layer of said multilayer film including a void creating additive and a whitening agent therein.

16. The film overlay of claim 15, wherein said opposed surface is a printable surface.

17. The film overlay of claim 15, wherein said opposed surface is provided with a coating from the group consisting of scratch resistant coatings, a scuff resistant coatings and metal coatings.

18. The film overlay of claim 15, wherein said polyolefin is polypropylene.

19. The film overlay of claim 15, wherein said void creating additive is calcium carbonate and said whitening agent is titanium dioxide.

20. The film overlay of claim 15, wherein said void creating additive is present in an amount of between about 10% and 25% by weight and said whitening agent is present in an amount of less than 5% by weight, all based upon the weight of the core layer.

21. The decorative film of claim 20, wherein said whitening agent is present in an amount of from about 1.5% to about 3% by weight, based upon the weight of the core layer.

22. The decorative film of claim 19, wherein said calcium carbonate is present in an amount of between about 10% and 25% by weight and said titanium dioxide is present in an amount of less than 5% by weight, all based upon the weight of the core layer.

23. The decorative film of claim 22, wherein said titanium dioxide is present in an amount of from about 1.5% to about 3% by weight, based upon the weight of the core layer.

24. The decorative film of claim 15, wherein said functional adhesive primer is selected from the group consisting of acrylic coatings, ethylene vinyl acetate coatings, polyethylene imine coatings, polyester coatings, polyamide coatings and urethane coatings.

25. The decorative film of claim 15, said void creating additive being present in an amount of about 10% to about 25%, by weight of said core layer.

26. The decorative film of claim 25, wherein said void creating additive is calcium carbonate.

27. A construction laminate structure including the film overlay of claim 15 adhered to a substrate employed in the construction field through a water-based adhesive disposed between the functional adhesive primer and the substrate to form a laminated construction panel.

28. The laminate structure of claim 27, wherein said substrate is selected from the group consisting of gypsum, lauan plywood, medium density fiberboard, hardboard and particle board, said decorative film overlay covering said substrate to form said laminated construction panel.

29. The laminate structure of claim 27, being in the group of construction laminates consisting of wall panels and ceiling panels.

30. The laminate structure of claim 28, being in the group of construction laminates consisting of wall panels and ceiling panels.

31. A film overlay for use in covering a substrate employed in laminates utilized in the construction field, said film overlay being a multilayer film including a core layer and opposed outer skin layers, said film overlay including on one surface thereof, a functional adhesive primer intended to receive an aqueous adhesive thereon, said film including an opposed surface providing a desired decorative appearance, said core layer of said multilayer film including a polyolefin blended with a void creating additive therein.

32. The film overlay of claim 31, wherein said opposed surface is a printable surface.

33. The film overlay of claim 31, wherein said opposed surface is provided with a coating from the group consisting of scratch resistant coatings, scuff resistant coatings and metal coatings.

34. The film overlay of claim 31, wherein said polyolefin is polypropylene.

35. The film overlay of claim 31, wherein said void creating additive is calcium carbonate.

36. The film overlay of claim 31, wherein said void creating additive is present in an amount of between about 10% and 25% by weight based upon the weight of said core layer.

37. The film overlay of claim 31, wherein said functional adhesive primer is selected from the group consisting of acrylic coatings, ethylene vinyl acetate coatings, polyethylene imine coatings, polyester coatings, polyamide coatings and urethane coatings.

38. A construction laminate structure including the film overlay of claim 31 adhered to a substrate employed in the construction field through a water-based adhesive disposed between the functional adhesive primer and the substrate to form a laminated construction panel.

39. The laminate structure of claim 38, wherein said substrate is selected from the group consisting of gypsum, lauan plywood, medium density fiberboard, hardboard and particle board.

40. The laminate structure of claim 38, being in the group of construction laminates consisting of wall panels and ceiling panels.

41. The laminate structure of claim 39, being in the group of construction laminates consisting of wall panels and ceiling panels.
